(19) United States
(12) Patent Application Publication
(10) Pub. No.: US 2026/0115819 A1
(43) Pub. Date: Apr. 30, 2026

(54) Film Lapping Device

(71) Applicant: NACHI-FUJIKOSHI CORP., Tokyo (JP)

(72) Inventors: Kenta NAKAMURA, Toyama (JP); Mitsuhiro KAWAHATA, Toyama (JP)

(73) Assignee: NACHI-FUJIKOSHI CORP., Tokyo (JP)

(21) Appl. No.: 19/204,653

(22) Filed: May 12, 2025

(30) Foreign Application Priority Data
Jun. 4, 2024 (JP) 2024-090763

(51) Int. Cl. B23F 19/02

(52) U.S. Cl. CPC B23F 19/02

(57) ABSTRACT

The present invention provides a film lapping device capable of detecting meshing between a gear-shaped workpiece and a gear-shaped backup tool, thereby reducing the burden on the operator and improving work efficiency. The configuration of the film lapping device according to the present invention includes the gear-shaped backup tool that meshes with the workpiece, the slide motor that moves the slide table toward or away from the workpiece holder, the tension sensor that detects the tension in the lapping film, and the controller including circuitry that operates the slide motor to move the slide table toward the workpiece holder and determines that the backup tool and the workpiece are meshed when the tension sensor detects an increase in the tension of the lapping film.

### CROSS-REFERENCE TO RELATED APPLICATION

This application is based upon and claims the benefit of priority from the prior Japanese Patent Application No. 2024-090763, filed on Jun. 4, 2024, the entire contents of which are incorporated herein by reference.

### BACKGROUND OF THE INVENTION

### Field of the Invention

The present invention relates to a film lapping device for lapping the tooth surfaces of a gear-shaped workpiece using a lapping film.

### Description of the Related Art

As a method for lapping metal component workpieces, film lapping is widely known. Film lapping is a precision polishing method that uses a lapping film coated with abrasive particles on its surface. One example of film lapping is disclosed in Patent Document 1, which describes a precision polishing method for external gear teeth. The precision polishing method for external gears in Patent Document 1 (Japanese Patent Application Laid-Open No. 2000-205377) is characterized by “pressing an abrasive film material against a tooth surface of the external gear as backed up with a pressing member, and in this state, sliding the teeth of the external gear and the abrasive film material relative to each other in a tooth profile direction to precision polish the tooth surface”.

### SUMMARY OF THE INVENTION

In order to solve the above-mentioned problems, a representative configuration of a film lapping device according to the present invention is a film lapping device for lapping a tooth surface of a gear-shaped workpiece with a lapping film, which is equipped with a workpiece holder that rotatably holds the workpiece; a gear-shaped backup tool that meshes with the workpiece with the lapping film interposed therebetween; a supply reel that feeds the lapping film to the backup tool; a take-up reel that collects the lapping film from the backup tool; a slide table on which the backup tool, the supply reel, and the take-up reel are mounted; a slide motor that moves the slide table in a direction toward or away from the workpiece holder; a tension sensor that detects tension of the lapping film; and a controller including circuitry that operates the slide motor to move the slide table toward the work piece holder and determines that the backup tool and the workpiece are meshed when the tension sensor detects an increase in the tension of the lapping film.

### BRIEF DESCRIPTION OF THE DRAWINGS

FIG. 1 is an overall perspective view of the film lapping device according to the present embodiment.

FIG. 2 is a diagram showing the film lapping device in FIG. 1 as viewed from the side.

FIG. 3A is a side view of essential parts showing a non-operating state of the film lapping device in FIG. 1.

FIG. 3B is a side view of essential parts illustrating an example of a state in which the backup tool and workpiece are meshed.

FIG. 4 is a side view of essential parts showing a state where the backup tool and workpiece are not meshed.

### EMBODIMENTS OF THE INVENTION

Preferred embodiments of the present invention will be described in detail below with reference to the accompanying drawings. The dimensions, materials, and other specific numerical values shown in this embodiment are merely examples for the purpose of facilitating understanding of the invention, and, unless specifically noted, do not limit the present invention. In the present specification and drawings, elements having substantially the same function and configuration are assigned the same reference numerals to avoid redundant explanation, and additionally, elements not directly related to the present invention are omitted from the illustrations and descriptions.

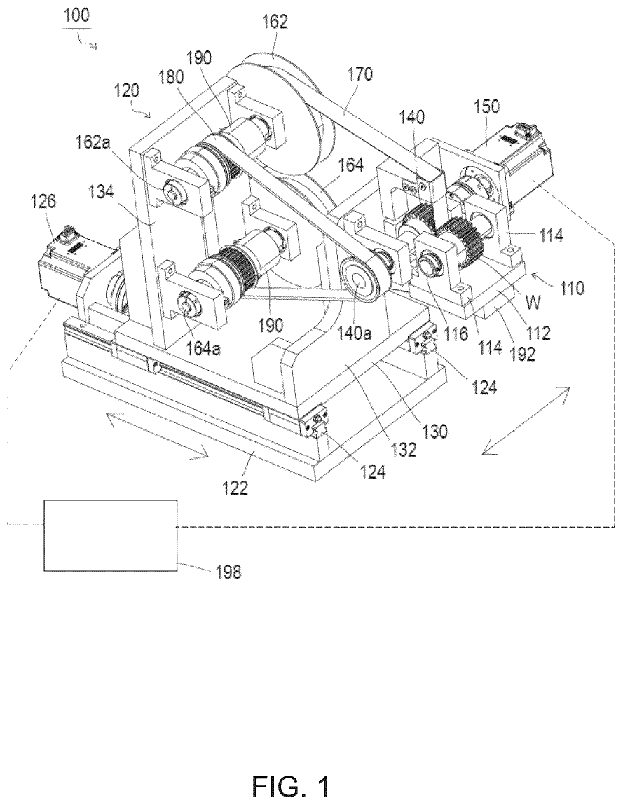

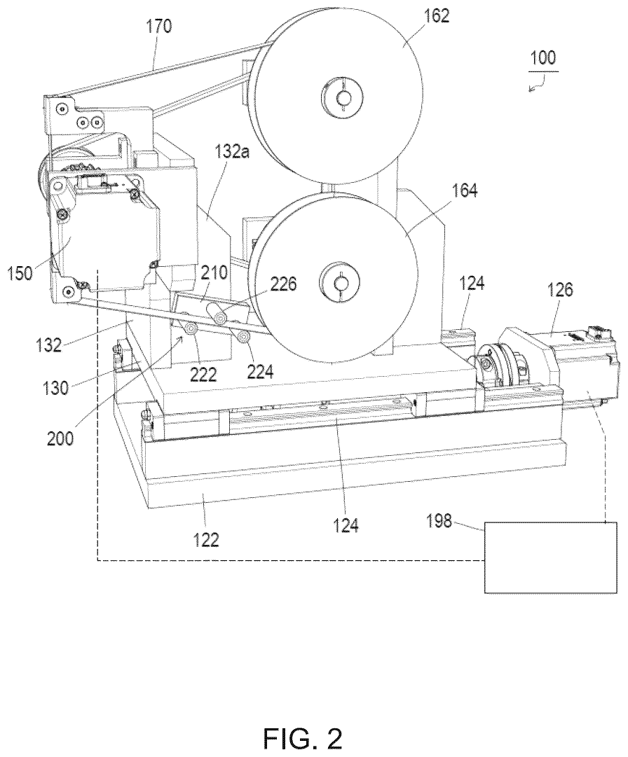

FIG. 1 is an overall perspective view of the film lapping device (hereinafter referred to as a lapping device 100) according to the present embodiment. FIG. 2 is a diagram showing the lapping device 100 in FIG. 1 as viewed from the side thereof. The lapping device 100 shown in FIG. 1 and FIG. 2 is used for lapping tooth surfaces of a gear-shaped workpiece W using a lapping film 170. The lapping device 100 is connected to a controller 198, which includes circuitry that controls operations of components such as a slide motor 126 and a tool rotation motor 150.

As shown in FIG. 1, the lapping device 100 of the present embodiment is equipped with a workpiece holder 110 and a lapping module 120. Although the workpiece holder 110 appears to be floating in FIG. 1, the workpiece holder 110 is actually fixed to a table (not shown). The workpiece holder 110 has a workpiece table 112, a pair of holders 114, and a shaft 116. The pair of holders 114 are attached to the workpiece table 112, and the shaft 116 is inserted through the pair of holders 114. The workpiece W is inserted onto the shaft 116 so that the workpiece W is rotatably supported by the workpiece holder 110.

The lapping module 120 is equipped with a base 122, a slide table 130, a first support wall 132, a second support wall 134, a backup tool 140, a tool rotation motor 150, a supply reel 162, and a take-up reel 164.

A rail 124, on which the slide table 130 travels, and a slide motor 126 are mounted on the base 122. According to this configuration, by driving the slide motor 126, the slide table 130 can travel along the rail 124 and slide over the base 122. As a result, the backup tool 140 moves toward or away from the workpiece W.

The first support wall 132 and the second support wall 134 are attached to the slide table 130 in a spaced-apart manner. The backup tool 140 and the tool rotation motor 150 are supported by the first support wall 132. The supply reel 162 and the take-up reel 164 are supported by the second support wall 134.

The backup tool 140 is a component that meshes with the workpiece W with the lapping film 170 interposed therebetween. The tool rotation motor 150 is a driving source that rotates the backup tool 140. The slide motor 126 moves the slide table 130 in a direction toward or away from the workpiece holder 110.

The supply reel 162 feeds the lapping film 170 to the backup tool 140. The take-up reel 164 collects the lapping film 170 from the backup tool 140. The backup tool 140, supply reel 162, and take-up reel 164 are mounted on the slide table 130.

As shown in FIG. 2, the lapping device 100 of the present embodiment is equipped with a tension sensor 200 that detects a tension of the lapping film 170. The tension sensor 200 is fixed to a support part 132a provided on a rear surface of the first support wall 132. The tension sensor 200 includes two fixed pins 222 and 224 and one movable pin 226, all of which are provided on a fixed plate 210, with the lapping film 170 positioned therebetween.

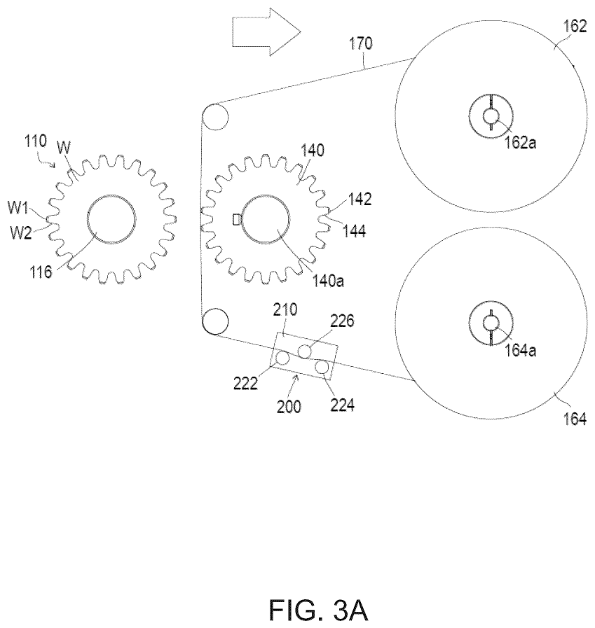

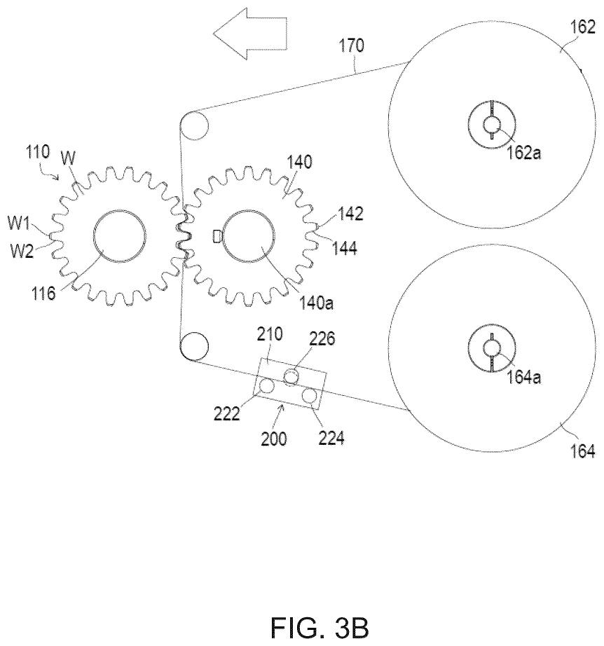

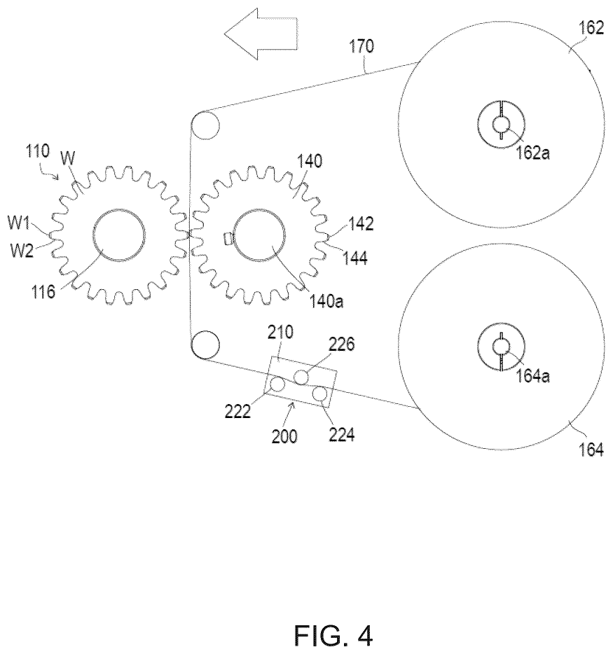

FIG. 3A illustrates an example of a state in which the lapping device 100 is not in operation. FIG. 3B illustrates an example of a state in which the backup tool 140 is engaged with the workpiece W. FIG. 4 shows a state in which the backup tool 140 is not engaged with the workpiece W.

As shown in FIG. 3A and FIG. 3B, the gear-shaped workpiece W has a rectangular external tooth W1, and in this embodiment, the tooth surface W2 of the external tooth W1 is subject to lapping. The backup tool 140 is a gear with the same module as the workpiece W and is also provided with a rectangular external tooth 142 similar to the workpiece W.

When the lapping device 100 is not operating, as an example shown in FIG. 3A, the lapping film 170 is separated from the workpiece W and is stretched across the front face of the backup tool 140. At this time, in the tension sensor 200, the lapping film 170 is stretched along the fixed pins 222 and 224 and the movable pin 226.

When processing the workpiece W, the controller 198 with circuitry operates the slide motor 126 to move the slide table 130 toward the workpiece holder 110. In other words, the controller 198 moves the lapping module 120 relative to the workpiece W. When the teeth and tooth grooves of the backup tool 140 and the workpiece W are properly engaged, the lapping film 170 is sandwiched between the teeth of the backup tool 140 and the workpiece W, as shown in FIG. 3B, and conforms to the gap therebetween. As a result, a lapping surface of the lapping film 170 comes into contact with the tooth surface W2 of the workpiece W.

At this time, tension is generated in the lapping film 170 as the lapping film 170 conforms to the teeth of the backup tool 140 and the workpiece W. As a result, in the tension sensor 200, an increase in the tension of the lapping film 170 causes a positional shift in the movable pin 226. Accordingly, the controller 198 detects an increase in the tension of the lapping film 170 by means of the tension sensor 200 and determines that the backup tool 140 and the workpiece W have been engaged with each other.

As shown in FIG. 4, when the teeth and tooth grooves of the backup tool 140 and the workpiece W are not engaged, that is, when the teeth of both parts abut against each other, the tension sensor 200 does not detect an increase in the tension. This is because the lapping film 170 is merely sandwiched between the teeth of both backup tool 140 and the workpiece W but the path length of the lapping film 170 does not change. Then, if the slide table 130 moves to the planned position without any change in the tension, possibly due to deformation of the backup tool 140 or another component, it can be determined that the meshing has failed. Instead of the slide table 130 moving to the planned position, if the driving torque or driving current of the slide motor 126 increases beyond a predetermined value, it can also be determined that the slide table 130 has stopped without any change in the tension.

When it is determined that meshing has failed, the slide table 130 is slightly moved backward, and the backup tool 140 is rotated by the tool rotation motor 150 by approximately ⅓ pitch to ½ pitch to move the slide table 130 closer to the workpiece W again. This removes the condition in which the teeth interfere with each other, thereby enabling proper meshing between the teeth and tooth grooves of the backup tool 140 and the workpiece W.

With the above configuration, the backup tool 140 and the workpiece W can be brought into mesh automatically and reliably. This eliminates the need for the operator to manually check the meshing between the backup tool 140 and the workpiece W, thereby reducing the burden on the operator and improving work efficiency.

When the tool rotation motor 150 is driven in the state illustrated in FIG. 3B, the backup tool 140 rotates, and the workpiece W is driven to rotate accordingly. Accordingly, the tooth surface 144 of the external tooth 142 of the gear-shaped backup tool 140 presses the lapping film 170 against the tooth surface W2 of the external tooth W1 of the workpiece W. As a result, the tooth surface W2 of the external tooth W1 of the workpiece W can be effectively fine-polished by the lapping film 170. Hence, the smoothness of the tooth surface W2 of the workpiece W is enhanced, thereby improving the noise reduction and the vibration suppression performances after assembly into a product.

Additionally, the lapping device 100 of this embodiment includes an oscillation device 192 that swings the workpiece holder 110 in a width direction. The oscillation device 192 allows for an oscillation (micro-vibration) of the workpiece W along with the above-described lapping of the external tooth W1 of the workpiece W. Accordingly, the smoothness of the tooth surface W2 of the workpiece W can be improved, making it possible to enhance the effects described above.

Also, as shown in FIG. 1, in the lapping device 100 of this embodiment, a shaft 140a of the backup tool 140, a shaft 162a of the supply reel 162, and a shaft 164a of the take-up reel 164 are connected by a drive belt 180. Accordingly, when the tool rotation motor 150 is driven to rotate the shaft 140a of the backup tool 140, the drive belt 180 transmits the rotation to the shaft 162a of the supply reel 162 and the shaft 164a of the take-up reel 164. As a result, a dedicated motor for rotating the supply reel 162 and take-up reel 164 is not required, thereby reducing equipment costs.

However, the supply reel 162 and the take-up reel 164 vary the amount of feeding and collecting of the lapping film 170 depending on the reel diameter of the lapping film 170. Therefore, in the lapping device 100 of this embodiment, a torque limiter 190 is provided on each of the shaft 162a of the supply reel 162 and the shaft 164a of the take-up reel 164. The torque limiter 190 absorbs the difference between the amount of supply from the supply reel 162 and the amount of take-up by the take-up reel 164, which is caused by the feed amount of the lapping film 170 corresponding to the drive of the tool rotation motor 150. Accordingly, it is possible to favorably prevent damage caused by slack or excessive tension in the lapping film 170.

As described above, with reference to the attached drawings, preferred embodiments of the present invention have been explained. However, it goes without saying that the present invention is not limited to the described examples. It is clear that a person skilled in the art could conceive of various modifications or variations within the scope of the claims, and such modifications and variations are naturally considered to fall within the technical scope of the present invention.

### INDUSTRIAL APPLICABILITY

The present invention can be utilized in film lapping devices for lapping the tooth surfaces of gear-shaped workpieces using a lapping film.

What we claim is:

1. A film lapping device for lapping a tooth surface of a gear-shaped workpiece with a lapping film, comprising:
a workpiece holder, with which the workpiece is rotatably held;
a gear-shaped backup tool that meshes with the workpiece with the lapping film interposed therebetween;
a supply reel that feeds the lapping film to the backup tool;
a take-up reel that collects the lapping film from the backup tool;
a slide table on which the backup tool, the supply reel, and the take-up reel are mounted;
a slide motor that moves the slide table in a direction toward or away from the workpiece holder;
a tension sensor that detects tension of the lapping film; and
a controller including circuitry that operates the slide motor to move the slide table toward the work piece holder and determines that the backup tool and the workpiece are meshed when the tension sensor detects an increase in the tension of the lapping film.
